(19) United States
(12) Patent Application Publication
(10) Pub. No.: US 2003/0006887 A1
(43) Pub. Date: Jan. 9, 2003

(54) Self-contained back-up warning system

(76) Inventors: Bruce Rossini, Whitmore Lake, MI (US); Julien I. Tudor, Clinton Twp., MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/189,613

(22) Filed: Jul. 3, 2002

Related U.S. Application Data
(60) Provisional application No. 60/302,745, filed on Jul. 3, 2001.

(51) Int. Cl. B60Q 1/00

(52) U.S. Cl. 340/425.5; 340/463

(57) ABSTRACT

A motion detector for use with trailers and the like. The motion detector includes a modular unit with its own power source, a motion detector, logic circuit and electro-audio warning device. The power supply is preferably a rechargeable battery. The motion detector may be an ultra-sonic motion detector which uses the Doppler effect to determine motion. The motion detector produces a signal which indicates the direction of travel and the speed of movement. The logic system discriminates between forward and reverse motion and issues a signal when the vehicle is moving in a reverse direction. The signal activates an electro-audio device which produces a pulse audio warning in response to the movement.

### BACKGROUND OF THE INVENTION

This application claims the benefit of U.S. Provisional Application No. 60/302,745, filed Jul. 3, 2001.

### BRIEF DESCRIPTIONS OF THE INVENTION

Back-up alarms are frequently used in large vehicles such as heavy-duty trucks and construction vehicles. These systems are typically connected to the gearshift linkage so that when the shift linkage is moved to engage the reverse gear, a signal is delivered to a device to generate an audio warning. Other warning systems, such as disclosed in U.S. Pat. No. 3,827,024, utilize sensors which are continuously operative to detect movement of the vehicle. A permanent magnet is mounted to the brake drum. A pair of reed switches are positioned near the brake drum so that movement of the magnet momentarily closes. The order of the closing of the switches is used to sense direction and movement. Electrical current is provided to the system from the vehicle battery. Such systems are not satisfactory for use on trailers which are frequently moved around freight yards with fork lifts. When moved in this manner, the trailers are not electrically connected to the fork lift or cab and, accordingly, are not provided with current electrical power to operate a warning device.

Also known is a warning system which monitors the movement of the drive shaft or wheel such as disclosed in U.S. Pat. No. 5,132,665 to Hutchisson, et al. Hutchisson, et al. discloses a mounted vehicle back-up alarm which is mounted to the hub of the vehicle. However, such devices require careful balancing of the device and are cumbersome to install.

Accordingly, it is desirable to provide a self-contained, easily installed back-up warning system that can be used on trailers and the like.

### SUMMARY OF THE INVENTION

These and other objects of the invention are accomplished by providing a modular motion alarm. The motion alarm consists of a housing containing a power supply, a motion detector, a logic circuit and an electro-audio warning device. The power supply is preferably a rechargeable battery. The motion detector is preferably an ultra-sonic motion detector which uses the Doppler effect to determine motion. The motion detector produces a signal which indicates the direction of travel and the speed of movement. The logic system discriminates between forward and reverse motion and issues a signal when the vehicle is moved in a reverse direction. The signal activates an electro-audio device which produces a pulsed audio warning in response to the movement.

### BRIEF DESCRIPTION OF THE DRAWING

A better understanding of the present invention will now be had with reference to the accompanying drawing wherein like reference characters refer to like parts throughout the several views herein in which:

FIG. 1 is a side view of a semi-trailer having a modular warning system in accordance with the invention;

FIG. 2 is a diagram showing a housing and components of the system;

FIG. 3 is a block diagram showing an ultrasonic Doppler sensor;

FIG. 4 is a block diagram showing a frequency discriminator in accordance with the invention; and

FIG. 5 is a flow chart showing components of the electro-acoustic device.

### DETAILED DESCRIPTION OF THE PREFERRED EMBODIMENTS

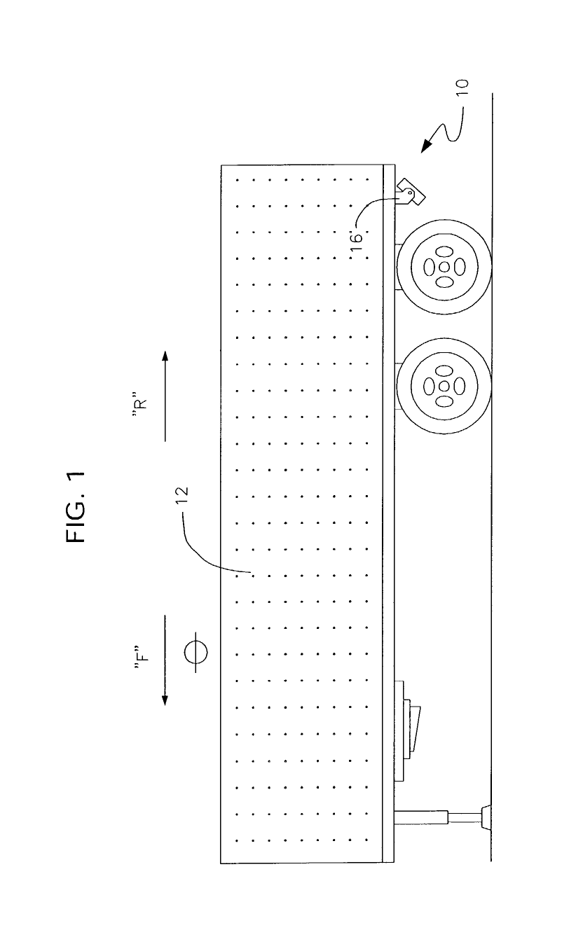

As shown in FIG. 1, a self-contained motion alarm device 10 is shown mounted to a vehicle such as a semi-trailer 12. The motion alarm device 10 is suitable for use with any type of vehicle, but is particularly suited for use with trailers such as semi-trailers, boat trailers, etc. The motion alarm 10 is a self-contained module which includes a housing 14 and a bracket 16 for mounting the housing to the trailer 12. The motion alarm may be easily mounted to any vehicle either as after-market equipment or at the time of the manufacturing of the trailer. As discussed below, the housing must be mounted in a particular alignment. The bracket 16 is provided to facilitate the alignment of the housing 14 on after-market vehicles. The bracket 16 is mounted ear a rear end of the trailer 12 under a deck or floor of the trailer.

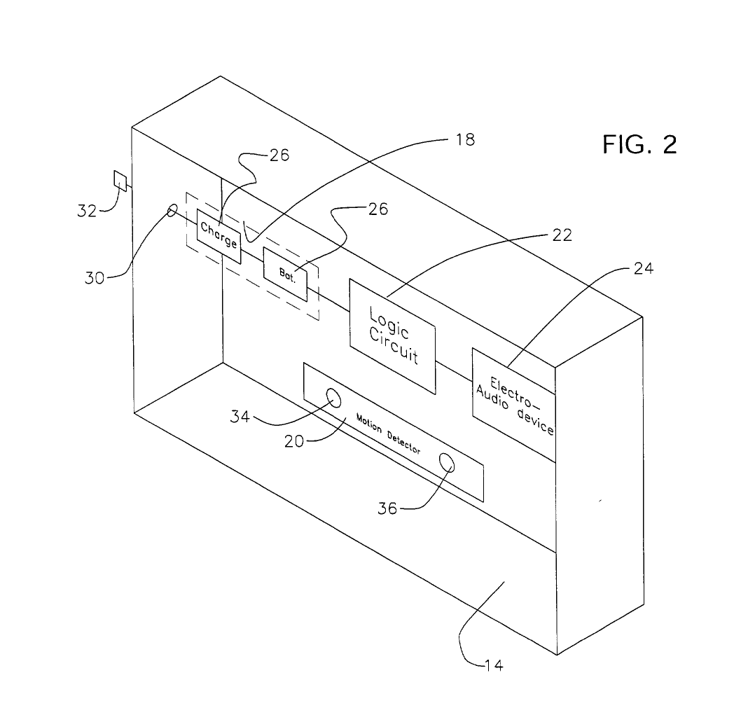

As shown in FIG. 2, the housing 14 contains an electrical power supply 18, a motion detector 20, logic circuit 22, and an electro-acoustic device 24. The power supply 18 includes a rechargeable battery 26 such as a lithium cadmium battery and a conventional recharging device 28. A connector 30 is provided on the housing 14 for connecting the recharging device 28 to a lighting system 32 of the trailer 12. The recharging device 28 recharges the batteries when the trailer is connected to the electrical system of a cab or car towing the trailer and the lighting system 32 is energized. As is known in the art, the system may be provided with a switch or relay which is activated at low voltage and connected to an audio device to provide a signal when the batteries are low.

The motion detector 20 of the preferred embodiment is an ultrasonic motion detector which uses Doppler effect to determine motion. A suitable device is discussed in Ultrasonic Doppler Sensor For Measuring Vehicle Speed in Forward and Reverse Motions, Including Low Speed Motions, Imou et al., Agricultural Engineering International: the CIGR Journal of Scientific Research and Development Manuscript PM 01 007. Vol. III.

Although the invention is discussed with respect to an ultrasonic Doppler speed sensor, other speed sensors, such as radar or inertial switches can be utilized. Doppler sensors are particularly useful because of the sensitivity in low speed ranges.

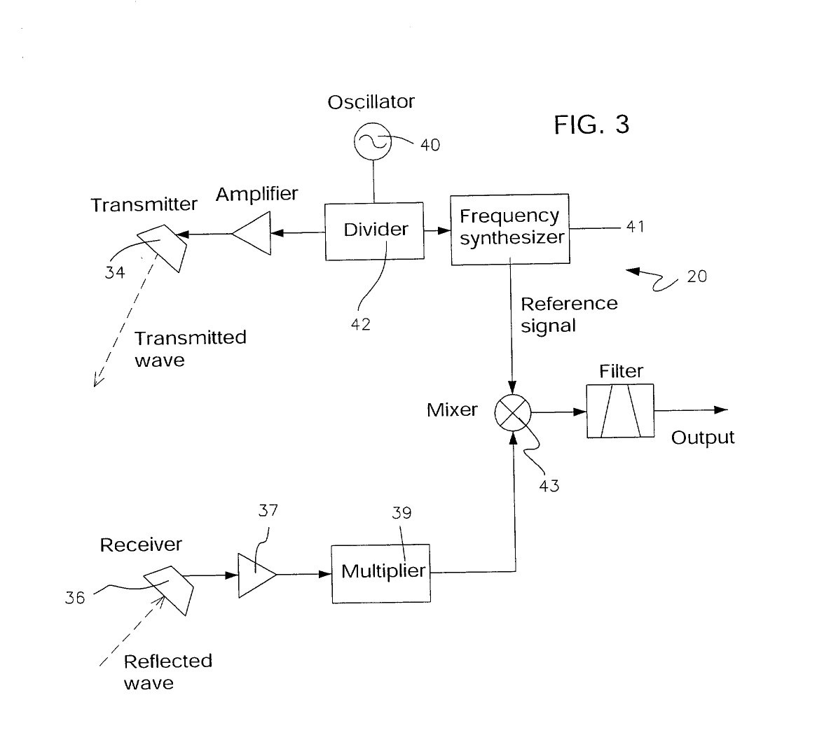

As shown in FIG. 3, the motion detector 20 includes a pair of sensors, namely, an ultrasonic transmitter 34 and an ultrasonic receiver 36 connected to a synthesis and processing circuit. The sensors are of the type produced by Murata Manufacturing Co., Model MA200A1. As discussed in detail in the Imou article, the transmitter 34 and receiver 36 are mounted at an angle of 45° to the ground. The transmitter 34 is connected to an oscillator 40 and divider 42. The transmitter 34 emits a signal of 200 kHz. The frequency of the signal received by the receiver 36 is delivered to an amplifier 37 and a frequency multiplier 39 where the signal is mixed with a reference signal from a frequency synthesizer 41 of a mixer 43. The mixer 43 outputs a signal of the differential frequency. The mixer 43 has a neutral output of 50 kHz when the sensors are not moving. The output frequency changes upwardly or downwardly in proportion to the travel speed. An increase in frequency indicates travel in one direction, such as a forward direction “F” and a decrease in frequency indicates a travel in the opposite or reverse direction “R”.

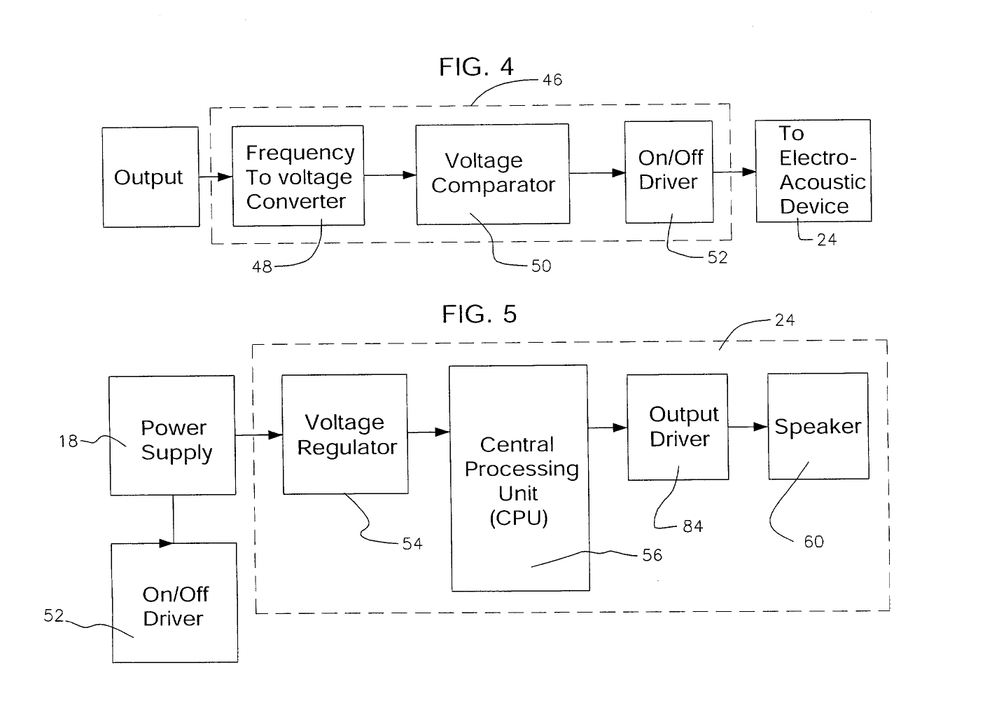

As shown in FIG. 4, the output signal 47 from the motion detector 20 is delivered to a logic circuit 46 having a frequency discriminator. The signal is delivered to a voltage converter 48 and a voltage comparator 50. The voltage comparator 50 is set to change its status only when the output of the voltage converter has a voltage level corresponding to a negative change in frequency. When the voltage comparator 50 provides a signal indicating a negative change in frequency, a signal is delivered to an on/off driver 52 to close the circuit to the power supply 18 enabling electro-acoustic device 24.

As shown in FIG. 5, the electrical current is delivered from the power supply to a voltage regulator 54 of the electro acoustic device 24 which delivers a regulated voltage to a central processing unit (CPU) 56. The central processing unit 56 enables a software routine to filter out transient signals. The signal is delivered to an output driver 58 having hardware timer generating a frequency of 1,000 Hz. The timer is a pulse with modulation timer (PWM) which produces a frequency having a variable duty cycle. The CPU 56 controls the amount of energy absorbed by the output driver 58 by setting the value of the duty cycle. The higher the energy, the higher the sound pressure level will be. The output driver 58 then delivers an electrical pulse to a speaker 60 to produce the audio alarm where the incoming electrical pulses are converted to acoustic signals.

Alternatively, the system may be controlled to emit sound pulses at intervals proportional to the rate of speed of the vehicle.

Thus disclosed is a motion detector which is self-contained having low electrical consumption and high reliability. The system operates effectively at slow speeds and different types of ground. The device response surely only when the vehicle is moving in a reverse direction and there is no signal in the car when the vehicle stops. Although the present invention has been described in its preferred forms with a certain degree of particularity, it is understood that the present disclosure of the several preferred embodiments has been by way of example and that numerous changes in the detailed construction, combination of arrangements of the elements may be resorted to without departing from the spirit and scope of the invention as hereinafter claimed.

We claim:

1. A motion warning device for use with a vehicle, the device comprising:
a housing mounted to the vehicle, said housing containing a motion detector, a logic circuit, a power supply and an electro-audio device, the power supply having a battery, the motion detector providing a signal indicating movement of the motion detector, the logic circuit receiving the output signal from the motion detector and generating a signal representative of movement in one direction, the electro-audio device connected to the logic circuit to generate an audio tone in response to receiving the signal from the logic device.

2. The warning device of claim 1, wherein the power supply further comprises a recharging device for recharging the battery.

3. The warning device of claim 2, wherein the recharging device is electrically connected to an electrical system of the vehicle.

4. The warning device of claim 1, wherein the motion detector further comprises a pair of ultra-sonic sensors.

5. The warning device of claim 1, wherein the housing is mounted to the vehicle by a bracket.

6. A motion warning device of ruse with a vehicle, the device comprising:
a housing mounted to the vehicle, said housing containing a motion detector, a logic circuit, a power supply and an electro-audio device, the power supply having a battery, the motion detector having an ultra-sonic transmitter and providing a signal indicating movement of the motion detector, the logic circuit receiving the output signal from the motion detector and generating a signal representative of movement in one direction, the electro-audio device connected to the logic circuit to generate an audio tone in response to receiving the signal from the logic device.

7. The warning device of claim 1, wherein the power supply further comprises a recharging device of recharging the battery.

8. The warning device of claim 2, wherein the recharging device is electrically connected to an electrical system of the vehicle.
